(19) United States
(12) Patent Application Publication
(10) Pub. No.: US 2002/0187300 A1
(43) Pub. Date: Dec. 12, 2002

(54) Floor mat for automobile

(75) Inventors: Sakae Nakasuji, Shiga (JP); Tatsuhiko Tsumura, Shiga (JP)

Correspondence Address: SUGHRUE MION, PLLC, 2100 PENNSYLVANIA AVENUE, N.W., WASHINGTON, DC, 20037, US

(73) Assignee: JAPAN VILENE CO., LTD.

(21) Appl. No.: 10/152,796

(22) Filed: May 23, 2002

(30) Foreign Application Priority Data
May 24, 2001 (JP) 2001-156025

(51) Int. Cl. B32B 3/02

(52) U.S. Cl. 428/95

(57) ABSTRACT

A floor mat for an automobile consisting essentially of one or more porous material layers wherein a water-resistant pressure of the whole floor mat is 40 mmH₂O or more is disclosed.

### BACKGROUND OF THE INVENTION

1. Field of the Invention

The present invention relates to a floor mat for an automobile.

2. Description of the Related Art

A floor mat for an automobile is laid over a carpet floor in an automobile so as to prevent an adherence and staining of the carpet floor by dirt on shoes, such as soil, sand, mud, gravel, rainwater, or muddy water, or drinks spilled by a driver or a passenger.

As shown in FIG. 9, which is a schematic exploded sectional view, a conventional floor mat 30 for an automobile comprises an upper face layer 31 of a carpet or the like and a base layer 35 of a rubber, a thermoplastic elastomer or the like. The carpet upper face layer 31 comprises, for example, a pile layer 31a and a substrate layer 31b, and the base layer 35 supports the upper face layer 31. In the above-mentioned floor mat 30, the base layer 35 provides durability, and projections from the surface of the base layer 35 provide a slip resistance.

The conventional floor mat 30 as above contains the base layer 35 and thus is very heavy. Therefore, when an automobile is driven with the conventional floor mats, an amount of fuel consumed is increased, and the environment is badly influenced.

Japanese Unexamined Patent Publication (Kokai) No. 2001-47926 discloses a lightweight floor mat for an automobile, that is, a mat mainly composed of a pile structure of a surface layer and a low density porous sound absorbing material layer stuck to the reverse side of the pile structure, and having a flexibility for fitting a shape of a carpet floor as a whole. Nevertheless, an object of the mat is to provide a sound absorbing property, and the mat is mainly composed of the porous sound absorbing material. Thus, the mat does not exhibit a required function as a floor mat for an automobile, i.e., a function to prevent a carpet floor from being stained by muddy water or the like, and therefore, is of no practical use.

### SUMMARY OF THE INVENTION

Of course, a floor mat for an automobile can be made lighter, by using a lightweight base layer of a porous material such as a foam instead of a heavy base layer such as a rubber, a thermoplastic elastomer or the like, and thus an amount of fuel used can be reduced. The inventors of the present invention engaged in intensive research to realize a saving of weight, while maintaining a most fundamental function required by a floor mat for an automobile, that is, a property of preventing a carpet floor from being stained by rainwater, muddy water, or spilled drinks. Nevertheless, this was very difficult.

As a result of the intensive research, the present inventors found that, when a floor mat satisfies a particular property, a lightweight floor mat for an automobile can be realized, while maintaining an excellent function to prevent a carpet floor from being stained. The present invention is based on the above findings.

Accordingly, the object of the present invention is to provide a lightweight floor mat for an automobile which can exhibit an excellent function of preventing a carpet floor from being stained.

Other objects and advantages of the present invention will be apparent from the following description.

In accordance with the present invention, there is provided a floor mat for an automobile consisting essentially of one or more porous material layers wherein a water-resistant pressure of the whole floor mat is 40 mmH₂O or more. The floor mat for an automobile according to the present invention is weight-saving because it consists essentially of one or more porous material layers as above, and rainwater, muddy water, spilled drinks or the like are less likely to permeate the floor mat and stain the carpet floor, because the water-resistant pressure of the whole floor mat is 40 mmH₂O or more.

According to a preferred embodiment of the present invention, a permeability of the whole floor mat is 0.3 mL/cm²/sec or more. The floor mat having a permeability of 0.3 mL/cm²/sec or more exhibits a sound absorbing property, and when a carpet floor on which the present floor mat is laid in the automobile has a sound absorbing property, an excellent absorbing function is obtained. Further, the floor mat according to the present invention may contain a deodorant, an aromatic, an antimicrobial agent, a fungicide, or the like. In particular, a deodorant, an aromatic, an antimicrobial agent, a fungicide, or the like can effectively exhibit their properties when contained in the present floor mat having a permeability of 0.3 mL/cm²/sec or more.

According to a further preferred embodiment of the present invention, the porous material layer as an upper surface layer of the floor mat is a carpet layer. The floor mat having the carpet upper surface layer has an excellent decorative effect. When a permeability of the carpet upper surface layer alone is 2 mL/cm²/sec or more, permeable properties of other porous material layers located under the carpet upper surface layer can be effectively exhibited, and a sound absorbing property of the whole floor mat becomes excellent. When a carpet floor on which the present floor mat is laid in the automobile has a sound absorbing property, an excellent absorbing function is obtained. Further, when a deodorant, an aromatic, an antimicrobial agent, a fungicide, or the like is contained in the present floor mat having the carpet upper surface layer with a permeability of 2 mL/cm²/sec or more alone, their properties can be effectively exhibited.

According to a still further preferred embodiment of the present invention, a fine-fibers nonwoven fabric layer comprising fine fibers having a diameter of 10 μm or less is contained as the porous material layer of an intermediate layer and/or a reverse side layer. When the present floor mat comprising the fine-fibers nonwoven fabric layer is used, rainwater, muddy water, spilled drinks or the like can be effectively prevented from reaching the carpet floor in an automobile. Further, a sound absorbing property is enhanced with an interaction of the carpet floor. When the fine-fibers nonwoven fabric layer contains a resin, the structure thereof becomes denser. Therefore, rainwater, muddy water, spilled drinks or the like can be more effectively prevented from reaching to the carpet floor, and a sound absorbing property is further enhanced.

According to a still further preferred embodiment of the present invention, a foam layer is contained as the porous material layer of an intermediate layer and/or a reverse side layer. The present floor mat containing the foam layer may exhibit various functions such as a cushioning property. When the floor mat has the foam layer as the reverse side layer, a slip-resistant property is obtained.

When the reverse side layer has a permeability of 0.3 to 20 mL/cm²/sec alone, a sound (particularly a treble sound of 2000 Hz or more) impinged from the reverse side of the floor mat can be reflected, to keep the inside of an automobile quiet.

When an exposed surface of the foam layer as the reverse side layer has a concave-convex structure, the convex portions can bite into the carpet floor of the automobile to enhance a slip resistance of the floor mat.

In accordance with the present invention, there is also provided a slip-proof floor mat for an automobile comprising

(1) the floor mat according to the present invention and

(2) projected portions of slip-resistant resin having a slip resistance value of 0.6N or more, the projected portions being partially located on an exposed surface of a reverse side layer of the floor mat.

When the projected portions of the slip-resistant resin having a slip resistance value of 0.6N or more are partially located on the exposed surface of the reverse side layer of the floor mat, a slip-resistant property of the floor mat for an automobile is enhanced without affecting the weight-saving of the floor mat. An apparent permeability of the floor mat can be maintained even if the slip-resistant resins are partially located on the exposed surface, and therefore, the slip-proof floor mat exhibits an excellent absorbing function with an interaction of the carpet floor. Further, when a deodorant, an aromatic, or the like is contained in the present the slip-proof floor mat, their properties can be effectively exhibited. Furthermore, when the water-resistant pressure of the whole slip-proof floor mat is 40 mmH₂O or more, the carpet floor is less likely stained.

### BRIEF DESCRIPTION OF DRAWINGS

FIG. 1 is a schematic sectional view of a dividable fiber which may be used to prepare the fine-fibers nonwoven fabric layer optionally contained in the present floor mat.

FIG. 2 is a schematic sectional view of another dividable fiber which may be used to prepare the fine-fibers nonwoven fabric layer optionally contained in the present floor mat.

FIG. 3 is a schematic sectional view of still another dividable fiber which may be used to prepare the fine-fibers nonwoven fabric layer optionally contained in the present floor mat.

FIG. 4 is a schematic sectional view of still another dividable fiber which may be used to prepare the fine-fibers nonwoven fabric layer optionally contained in the present floor mat.

FIG. 5 is a schematic sectional view of still another dividable fiber which may be used to prepare the fine-fibers nonwoven fabric layer optionally contained in the present floor mat.

FIG. 6 is a schematic exploded sectional view of one embodiment of the floor mat for an automobile according to the present invention, particularly the floor mats prepared in Examples 1 and 2, wherein the porous material layers in the floor mat are separated from each other.

FIG. 7 is a schematic exploded sectional view of another embodiment of the floor mat for an automobile according to the present invention, particularly the floor mat prepared in Example 3, wherein the porous material layers in the floor mat are separated from each other.

FIG. 8 is a schematic exploded sectional view of a still another embodiment of the floor mat for an automobile according to the present invention, particularly the floor mat prepared in Example 4, wherein the porous material layers in the floor mat are separated from each other.

FIG. 9 is a schematic exploded sectional view of the conventional floor mat for an automobile, particularly the floor mats prepared in Comparative Examples 1 and 2, wherein the layers in the floor mat are separated from each other.

FIG. 10 is a schematic exploded sectional view of another conventional floor mat for an automobile, particularly the floor mat prepared in Comparative Example 3, wherein the layers in the floor mat are separated from each other.

FIG. 11 is a graph showing a relationship of absorption coefficient and frequency for the floor mat for an automobile according to the present invention and a conventional floor mat for an automobile.

### DESCRIPTION OF THE PREFERRED EMBODIMENTS

The floor mat for an automobile according to the present invention consists essentially of one or more porous material layers, so that a saving of the weight of the floor mat is realized. The material used for the porous material layers of the floor mat for an automobile according to the present invention is not particularly limited so long as it is porous and a water-resistant pressure of the whole floor mat consisting essentially of one or more porous material layers is 40 mmH₂O or more. Examples of the porous material are a carpet, nonwoven fabric, woven fabric, knitted fabric, foam, breathable or permeable film, or microporous film, or crushed rubber laminate prepared by laminating crushed rubbers and adhering them by an adhesive.

Of the porous materials as above, the carpet has an excellent decorative effect, and can provide a comfortable driving effects and thus, it can be preferably used as the porous material layer of an upper surface layer of the floor mat for an automobile. The carpet is not particularly limited, but may be for example, a tufted carpet, a needle-punched carpet, a hand-knotted carpet, a hooked rug, a wilton carpet, a axminster carpet, or the like.

When the carpet layer contains functional fibers such as deodorizing fibers, antimicrobial fibers, or fungicidal fibers and the carpet layer is located as the upper surface layer, or when one or more porous material layers containing the functional fibers are not located as the upper surface layer, but the floor mat has a permeability, the functions of the functional fibers can be exhibited. Further, when the floor mat has a permeability, the floor mat containing functional resins such as deodorizing resins, antimicrobial resins, or fungicidal resins in addition to or instead of the functional fibers can exhibit the functional effect as above.

A permeability of the carpet layer alone which may be used as the porous material layer is preferably 2 mL/cm²/sec or more, more preferably 6 mL/cm²/sec or more.

The carpet which may be used as the porous material layer may be prepared by a conventional method.

In the present specification, the “upper surface layer” of the floor mat means a layer visiable when laid over the carpet floor in an automobile.

The floor mat for an automobile according to the present invention may contain one or more fine-fibers nonwoven fabric layers as the porous material layer. When the present floor mat contains the fine-fibers nonwoven fabric layer containing the fine fibers having a diameter of 10 μm or less, as one of the porous material layers, the floor mat can effectively prevent rainwater, muddy water, spilled drinks or the like from reaching the carpet floor and enhance a sound absorbing property with an interaction of the carpet floor.

The finer fiber diameter of the fine fibers forming the fine-fibers nonwoven fabric layer can exhibit more excellent functions in the above properties. Therefore, the fiber diameter of the fine fiber is preferably 5 μm or less, more preferably 3 μm or less. The lower limit of the fiber diameter is not particularly limited, but about 0.1 μm is suitable.

The term “fiber diameter” as used herein with respect to a fiber having a circular cross-sectional shape means a diameter of the circle. For a fiber having a non-circular cross-sectional shape, a diameter of a circle having an area the same as that of the non-circular cross-sectional shape is regarded as a diameter.

The fine fiber may be formed by any resin components, for example, one or more components of a polyamide-based resin (such as nylon-6 or nylon-66), a polyester based resin (such as polyethylene terephthalate or polybutylene terephthalate), a polyolefin based resin (such as polyethylene or polypropylene), a polyvinylidene chloride based resin, or the like. Of the above resins, the polyamide-based resin (such as nylon-6 or nylon-66) is preferable, because a water repellency can be easily imparted to the fine-fibers nonwoven fabric containing the polyamide-based resin by a treatment, as mentioned below, to obtain the floor mat for an automobile having a water-resistant pressure of 40 mmH₂O or more. Further, when the fine-fibers nonwoven fabric layer consists essentially of the fine fibers of the polyolefin based resin, the floor mat having a water-resistant pressure of 40 mmH₂O or more can be easily obtained. Therefore, the polyolefin based resin is also preferable.

The fine-fibers nonwoven fabric used in the present floor mat for an automobile may contain two or more resins different from each other with respect to a resin composition and/or fiber diameter.

The fine fiber as mentioned above may be prepared by dividing dividable fibers by a physical or chemical action, or a melt blowing method. The physical action may be, for example, a fluid jet, such as a water jet, a calendaring, or a flat-pressing, and the chemical action may be, for example, a removal or swelling of one or more resin components. Of these actions, the physical action to divide the dividable fiber is preferable, because fine fibers having an excellent strength and a fine-fibers nonwoven fabric having a dense structure can be obtained.

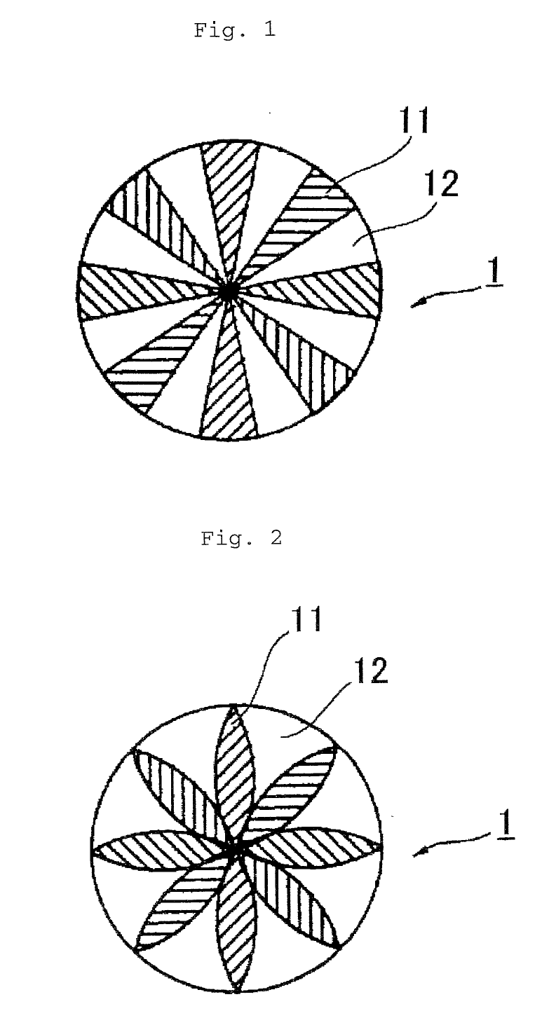

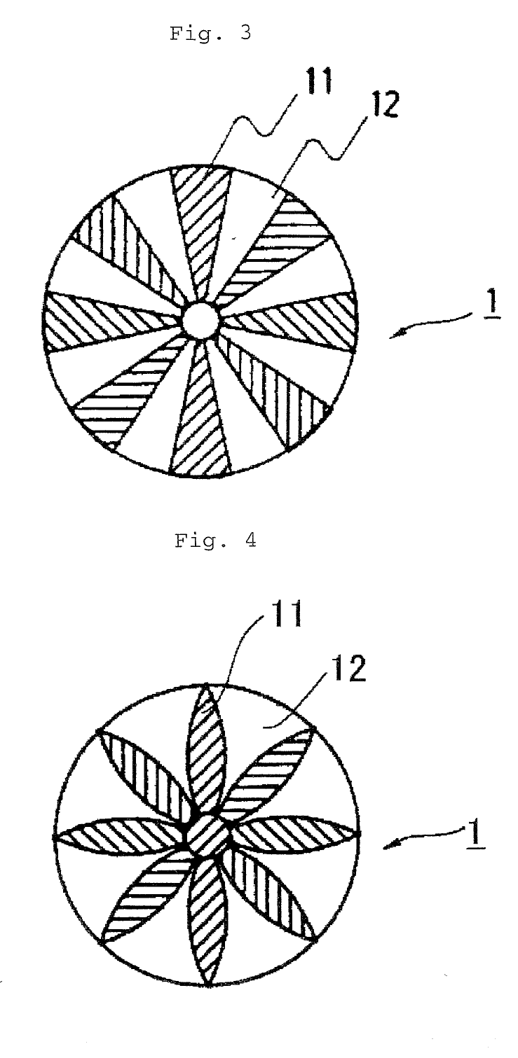

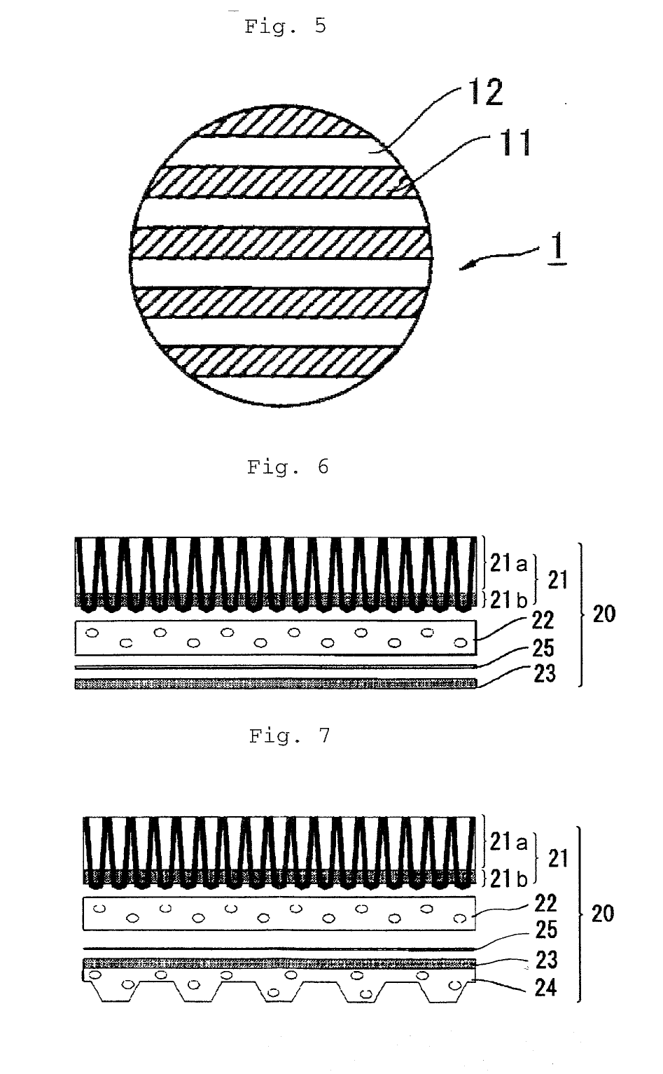

The dividable fiber by the physical or chemical action may be a conjugate fiber containing two or more resin components, for example, a dividable fiber 1 of an orange type conjugate fiber having a sectional view similar to that of an orange fruit (see FIGS. 1 to 4) or a dividable fiber 1 of a multiple bimetal type conjugate fiber having a sectional view similar to that of a multiple bimetal (see FIG. 5). As shown in FIGS. 1 to 5, a dividable fiber 1 contains at least two separated resin components 11, 12.

A fiber diameter of the dividable fiber is not particularly limited, so long as the dividable fiber can produce the fine fibers having the above-mentioned diameter. A fiber length of each of the dividable fiber and the fine fiber is not particularly limited, but the dividable fiber and the fine fiber may be a short fiber having a length of about 1 to 160 mm, or a long fiber having a longer length.

When an amount of the fine fibers is increased, the stain-preventing property and the sound absorbing property can be enhanced. Therefore, the fine fibers accounts for preferably 50 mass % or more, more preferably 80 mass % or more of the fine-fibers nonwoven fabric.

Fibers forming the fine-fibers nonwoven fabric other than the fine fibers may be, for example, a nylon based fiber, a vinylon based fiber, a vinylidene based fiber, a polyvinyl chloride based fiber, a polyester based fiber, an acryl based fiber, a polyolefin based fiber, a polyurethane based fiber, or an undivided dividable fiber, each having a fiber diameter of more than 10 μm. Further, the fine-fibers nonwoven fabric may contain functional fibers such as deodorizing fibers, heat-fusible fibers, or highly-crimping fibers.

The fine-fibers nonwoven fabric may be prepared by forming a fiber web containing dividable fibers as mentioned above by a dry-laid method, such as a carding method or an air-laying method, a spun-bonding method, or a wet-laid method, and then applying the physical or chemical action to the fiber web. If necessary, a heating treatment with or without partially or wholly applying a pressure may be carried out in addition to the physical or chemical action. When the fiber web is prepared by the melt-blowing method, the fine-fibers nonwoven fabric may be prepared without any further treatment, or by binding fibers to each other by a heat treatment with or without partially or wholly applying a pressure.

The fine-fibers nonwoven fabric may contain a resin to produce a denser structure. Therefore, very little rainwater, muddy water, spilled drinks or the like will permeate the fine-fibers nonwoven fabric containing the resin, and reach a carpet floor, and a sound absorbing property is further enhanced.

The resin which may be contained in the fine-fibers nonwoven fabric is not particularly limited, but for example, is a thermoplastic resin, such as isobutylene-maleic anhydride copolymer, acrylonitrile-styrene-acrylic rubber copolymer, acrylonitrile-ethylene-styrene copolymer, acrylonitrile-styrene-copolymer, acrylonitrile-butadiene-styrene copolymer, styrene-butadiene copolymer, ethylene-vinyl acetate copolymer, ethylene-vinyl chloride-vinyl acetate copolymer, or a thermosetting resin, such as epoxy resin, xylene resin, phenol resin, polyimide resin, polyurethane resin, melamine resin, urea resin, or a rubber, such as styrene-butadiene rubber, butadiene rubber, isoprene rubber, nitrile-butadiene rubber, butyl rubber, ethylene-propylene rubber, ethylene-propylene dinene rubber, urethane rubber, silicone rubber. Of these resins, acrylonitrile-ethylene-styrene copolymer, or ethylene-vinyl acetate copolymer is preferable.

When the fine-fibers nonwoven fabric contains such a resin, a carpet floor is little stained, and a sound absorbing property is enhanced. However, if an amount of the resin contained in the fine-fibers nonwoven fabric becomes large, the floor mat for an automobile becomes heavy. Therefore, the amount of the resin is preferably 5 to 100 g/m², more preferably 5 to 20 g/m².

The resin as mentioned above can be applied to the fine-fibers nonwoven fabric by spraying or coating a resin solution or emulsion, or by dipping the fabric in the resin solution or emulsion.

An area density, that is, a mass per 1 m², of the fine-fibers nonwoven fabric layer (including the case where the fabric contains the resin as above) is preferably 60 to 200 g/m², more preferably 70 to 120 g/m², so as to realize a weight-saving of the floor mat for an automobile. A thickness of the fine-fibers nonwoven fabric layer (including the case where the fabric contains the resin as above) is preferably about 0.2 to 0.6 mm. The thickness is determined in accordance with the method defined in JIS B 7502, that is, a value obtained by measuring a sample upon application of a 5 N load by an outside micrometer. An apparent density of the fine-fibers nonwoven fabric layer (including the case where the fabric contains the resin as above) is preferably 0.1 to 1 g/cm³, more preferably 0.12 to 0.6 g/cm³. The apparent density is a value obtained by dividing an area density with a thickness.

The floor mat for an automobile according to the present invention may contain one or more bulky-nonwoven fabric layers as the porous material layer. When the bulky-nonwoven fabric is contained in the floor mat, a sound absorbing property is enhanced. Therefore, it is preferable to use the bulky-nonwoven fabric layer in addition to or instead of the fine-fibers nonwoven fabric layer. The term “bulky-nonwoven fabric layer” as used herein means a nonwoven fabric layer having a thickness of 1 mm or more, and the thickness is a value measured upon applying a 10 g/1 cm² load. The floor mat containing the bulky-nonwoven fabric layer having larger thickness can enhibit a more excellent sound absorbing property, but the thickness of the bulky-nonwoven fabric layer is preferably 10 mm or less from a practical standpoint of view as a floor mat.

An area density of the bulky-nonwoven fabric layer is preferably 50 to 1000 g/m², more preferably 70 to 500 g/m², so that it can contribute to the weight-saving of the present floor mat for an automobile. An apparent density (a value obtained by dividing an area density with a thickness) of the bulky-nonwoven fabric layer is preferably 0.02 to 0.25 g/cm³, more preferably 0.035 to 0.17 g/cm³.

The bulky-nonwoven fabric may be prepared by, for example, (1) forming a fiber web by a dry-laid method and then needle-punching the fiber web, (2) forming a fiber web containing heat-fusible fibers by a dry-laid method, and then heating the fiber web without a pressure or under a slight pressure for adjusting a thickness to fuse the heat-fusible fibers, or (3) laminating melt-blown nonwoven fabrics containing fibers having a fiber diameter of 6.6 dtex or more.

The floor mat for an automobile according to the present invention may contain one or more foam layers as the porous material layer. When the foam layer is contained, various functions such as a cushioning property may be obtained. The foam used as the foam layer may be a closed-cell structure or an open-cell structure. When the open-cell foam layer is used, an excellent sound absorbing property is obtained, and further, functions of a deodorant or perfume which may be contained in the floor mat for an automobile are not affected.

A resin forming the foam layer is not particularly limited, but for example, a urethane resin, acrylic resin, styrene-butadiene copolymer resin, styrene-butadiene rubber, nitrilebutadiene rubber, isoprene rubber or the like.

A foaming magnification, i.e, a ratio (b/a) of a density before expansion (b) to a density after expansion (a), of the foam is not particularly limited, but is preferably 1.2 to 20 fold, more preferably 2 to 10 fold. This is because when the foaming magnification is large, a cushioning property is enhanced when heavily trod upon, whereas a thickness of the form is liable to decrease by deterioration.

An area density of the foam layer is preferably 200 to 1000 g/m², more preferably 300 to 500 g/m², so that it can contribute to the weight-saving of the present floor mat for an automobile. A thickness of the foam layer is preferably about 1 to 7 mm. When the foam layer has a concave-convex structure as mentioned below, the thickness means a thickness of a convex portion. An apparent density (a value obtained by dividing an area density with a thickness) of the foam layer is preferably 0.03 to 1 g/cm³, more preferably 0.04 to 0.5 g/cm³.

The foam used as the foam layer may be prepared by a conventional method.

The foam layer may be located as any layer in the floor mat for an automobile according to the present invention, i.e, as an upper surface layer, an intermediate layer or a reverse side layer. When the floor mat for an automobile contains the carpet layer and the fine-fibers nonwoven fabric layer or bulky nonwoven fabric as above, the foam layer is preferably located between the carpet layer and the fine-fibers nonwoven fabric layer or bulky nonwoven fabric. Such a structure can enhance an adhesiveness of the carpet layer and the fine-fibers nonwoven fabric layer or bulky nonwoven fabric, and thus, may avoid a peeling from each other. It is also preferable to use the foam layer as a reverse side layer in the present floor mat for an automobile, because a slipping of the floor mat for an automobile can be prevented. When the foam layer is used as the reverse side layer of the present floor mat for an automobile, the foam layer preferably possesses a concave-convex structure on an exposed surface (reverse side) so that a slipping of the floor mat for an automobile can be more effectively prevented.

The term “reverse side layer” as used herein means a layer directly in contact with a carpet floor of an automobile.

The floor mat for an automobile according to the present invention consists essentially of one or more porous material layers as above, and thus is lightweight. Preferred combinations of plural porous material layers are as follows (the following order is from the upper surface layer to the reverse side layer):

(1) the carpet layer—the foam layer—the fine-fibers nonwoven fabric layer,

(2) the carpet layer—the foam layer—the bulky nonwoven fabric layer,

(3) the carpet layer—the foam layer—the fine-fibers nonwoven fabric layer—the foam layer,

(4) the carpet layer—the foam layer—the bulky nonwoven fabric layer—the foam layer,

(5) the carpet layer—the fine-fibers nonwoven fabric layer—the foam layer, and

(6) the carpet layer—the fine-fibers nonwoven fabric layer.

The combination is not limited to the above-mentioned embodiments.

The above-mentioned floor mat for an automobile according to the present invention may be used to produce a slip-proof floor mat for an automobile to which the present invention also relates. The present slip-proof floor mat for an automobile may be produced by forming projected portions of a slip-resistant resin having a slip resistance value of 0.6 N or more, preferably 0.8 N or more, more preferably 1.2 N or more, on an exposed surface of the reverse side layer of the above-mentioned floor mat for an automobile according to the present invention. The projected portions are partially located on the exposed surface of the reverse side layer of the floor mat. Thus, the present slip-proof floor mat for an automobile has a partially-located-resins layer on the reverse side, and can enhance the property of preventing the slippage. It is preferable that a water-resistant pressure of the whole slip-proof floor mat is 40 mmH₂O or more.

A shape formed by the projected portions or the partially-located-resins, on the whole reverse side surface, is not particularly limited. For example, the projected resins are located in a lattice-like shape or a grid-like shape, or around a peripheral portions of the reverse side layer, dispersed as dots, or forms strips.

The “slip resistance value” means a value obtained in accordance with the following procedures:

(1) A resin sheet sample (140 mm×100 mm) having a smooth surface without any mechanical structure for preventing slippage is prepared from a resin to be examined.

(2) Fiber webs (area density=200 g/m²) are prepared from polyethylene terephthalate fibers (fineness=6.6 dtex; fiber length=74 mm; cross-sectional shape of fiber=circle; crimp number=10 to 13/inch) by a dry carding machine, and then crossed in a lengthwise direction of the fiber webs by a cross-layer (sharp angle of the fiber webs to the lengthwise direction of the crossed-laid fiber web=20°) to obtain a crossed-laid fiber web. Thereafter, the resulting crossed-laid fiber web is treated with a needle-punching at a needle density of 250 needles/cm² only from one side of the fiber web to obtain a needle-punched nonwoven fabric.

(3) The resin sheet sample is mounted on the needle-punched nonwoven fabric by bringing it into contact with a surface having raised fibers. The raised-fibers surface is opposite to the surface treated by inserting the needles. Subsequently, a load of 100 g is mounted on the resin sheet sample, and the resin sheet sample is slid at a speed of 100 mm/minute in a lengthwise direction of the resin sheet sample to measure a force at a maximum point of a slip resistance value.

(4) The above procedures are repeated five times, and an average of the resulting values is taken as a slip resistance value.

An example of the slip-resistant resin is a thermoplastic resin, such as isobutylene maleic anhydride copolymer, acrylonitrile-styrene-acrylic rubber copolymer, acrylonitrile-ethylene-styrene copolymer, acrylonitrile-styrene copolymer, acrylonitrile-butadiene-styrene copolymer, styrene-butadiene copolymer, ethylene-vinyl acetate copolymer, ethylene-vinyl chloride-vinyl acetate copolymer, or a rubber, such as styrene-butadiene rubber, butadiene rubber, isoprene rubber, nitrile-butadiene rubber, butyl rubber, urethane rubber, ethylene-propylene rubber, ethylene-propylene-diene-rubber, silicone rubber or the like.

The slip-resistant resin can be applied by, for example,

(1) a method wherein a thickened resin emulsion is dotted by a galvanized cylinder or the like,

(2) a processing method by a hot-melt applicator,

(3) an injection method from an injection nozzle, or

(4) a method wherein the slip-resistant resin is applied on desired portions of the surface of the reverse side porous material layer and then hot-pressed.

In the present floor mat for an automobile or the present slip-proof floor mat for an automobile, a peripheral portion is preferably covered with a resin so that the shape of the present floor mat for an automobile or the present slip-proof floor mat for an automobile can be maintained when laid over the carpet floor in the automobile even at an elevated temperature in midsummer. Further, the peripheral portion of the floor mat or the slip-proof floor mat for an automobile can be shaped by covering it with the resin so that the shape of the floor mat or the slip-proof floor mat for an automobile can be fitted to that of the floor of the automobile. Therefore, the floor mat or the slip-proof floor mat for an automobile may be unified with the floor, and the decorativeness thereof can be enhanced.

The resin which may be used for covering the peripheral portion is not particularly limited, so long as it may maintain the shape of the floor mat or the slip-proof floor mat for an automobile, but for example, is a thermoplastic resin, such as isobytylene maleic anhydride copolymer, acrylonitrile-styrene-acrylic rubber copolymer, acrylonitrile-ethylene-styrene copolymer, acrylonitrile-styrene copolymer, acrylonitrile-butadiene-styrene copolymer, styrene-butadiene copolymer, ethylene-vinyl acetate copolymer, or ethylene-vinyl chloride-vinyl acetate copolymer, a thermosetting resin, such as epoxy resin, xylene resin, phenol resin, polyimide resin, polyurethane resin, melamine resin, or urea resin, or a rubber, such as styrene-butadiene rubber, butadiene rubber, isoprene rubber, nitrile-butadiene rubber, butyl rubber, urethane rubber, ethylene-propylene rubber, ethylene-propylene-diene rubber, or silicone rubber.

The peripheral portion of floor mat or the slip-proof floor mat for an automobile can be covered with the resin by, for example, a heat-press molding, a cold-press molding after preheating, a stamping molding by a melt resin extrusion, an injection molding, or the like.

The floor mat for an automobile according to the present invention consists essentially of one or more porous material layers as above. Nevertheless, it has an excellent water-resistance, because the water-resistant pressure of the whole floor mat is 40 mmH₂O or more. Therefore, rainwater, muddy water, spilled drinks or the like are less likely to permeate the floor mat and stain the carpet floor. The water-resistant pressure of the whole slip-proof mat for an automobile according to the present invention is also preferably 40 mmH₂O or more. The water-resistant pressure of the present floor mat for an automobile or the present slip-proof floor mat for an automobile is preferable 80 mmH₂O or more, more preferably 200 mmH₂O or more.

The term “water-resistant pressure” as used herein means a value measured at a time when water is leaked from 3 or more portions upon raising a water level at a speed of 10 cm±0.5 cm/min by a leveling apparatus in accordance with an A method (low hydraulic pressure), in JIS L 1092:1998 6.1, a test for a degree of water-resistance, a method of a static hydraulic pressure.

The required water-resistant pressure may be imparted to the present floor mat for an automobile by, for example, (1) applying a water-repellant such as a fluoride water-repellant, or silicone-based water-repellant, or a material having a high hydrophobic property, such as a mineral oil or an aliphatic alcohol, to a reverse side of the carpet layer (which usually contains a primary substrate on the reverse side), the fine-fibers nonwoven fabric layer, or the foam layer,

(2) using the foam layer having the closed-cell structure,

(3) applying polyolefin powder to a reverse side of the carpet layer (which usually contains a primary substrate on the reverse side), the fine-fibers nonwoven fabric layer, or the foam layer,

(4) using a fiber sheet (such as a fine-fibers nonwoven fabric, woven fabric, or knitted fabric) consisting essentially of fibers having a surface consisting essentially of a polyolefin based resin, as the porous material layer, or

(5) using a microporous film as the porous material layer.

A combination of one or more of the above means (1) to (5) may be used.

When the floor mat for an automobile according to the present invention has a permeability of 0.3 mL/cm²/sec or more, it exhibits a function as a sound absorber, and an excellent absorbing function is obtained with an interaction of the carpet floor. Further, when functional fibers such as deodorant fibers, or functional resins such as deodorant resins or perfuming resins are contained in the floor mat for an automobile according to the present invention, their functions can be effectively exhibited. The permeability of the floor mat or the slip-proof floor mat for an automobile according to the present invention is preferably 2 mL/cm²/sec or more, more preferably 3 mL/cm²/sec or more. The upper limit of the permeability is not particularly limited, but is preferably about 60 mL/cm²/sec, more preferably 10 mL/cm²/sec.

The term “permeability” as used herein means a value obtained in accordance with JIS L 1096:1999 8.27.1, an A method, Frazier method.

It is believed that the permeability of the floor mat as a whole is dependent upon the lowest permeability of the porous material layers, such as the carpet layer, the fine-fibers nonwoven fabric layer, or the foam layer, in the whole floor mat. Therefore, the floor mat having the required permeability may be obtained by selecting suitable porous material layers.

When the carpet layer alone has a permeability of 2 mL/cm²/sec or more, the permeable properties of the porous material layers (such as the fine-fibers nonwoven fabric layer, or the foam layer) located under the carpet layer can be effectively utilized, and an excellent sound absorbing property can be obtained. The permeability of the carpet upper surface layer alone is preferably 4 mL/cm²/sec or more, more preferably 6 mL/cm²/sec or more, most preferably 7 mL/cm²/sec or more. Further, when the carpet layer alone has a permeability of 2 mL/cm²/sec or more, an excellent absorbing function is obtained with an interaction of the carpet floor. Further, when functional fibers such as deodorant fibers, or functional resins such as deodorant resins or perfuming resins are contained in the floor mat containing the carpet layer as mentioned above, their functions can be effectively exhibited.

When the reverse side layer alone has a permeability of 0.3 to 40 mL/cm²/sec, a sound (particularly a treble sound of 2000 Hz or more), that is, a noise outside an automobile, impinged from the reverse side of the floor mat can be reflected to keep the inside of an automobile quiet. The permeability of the foam layer is more preferably 0.3 to 10 mL/cm²/sec.

When an exposed surface the reverse side layer has a concave-convex structure, the convex portions can bite into the carpet floor of the automobile to enhance a slip resistance of the floor mat.

In the floor mat for an automobile according to the present invention, layers other than the carpet layer are composed of the porous material. Therefore, the present floor mat is lightweight, in comparison with a conventional floor mat comprising a base layer of a rubber, a thermoplastic elastomer or the like. More particularly, a total area density of the layers other than the carpet layer in the present floor mat for an automobile ranges from about 400 to about 1350 g/m², whereas the area density of the back layer of a rubber, a thermoplastic elastomer or the like in a conventional floor mat ranges from about 1700 to about 2400 g/m².

A process for producing the floor mat for an automobile according to the present invention is not particularly limited, but the present floor mat containing two or more porous material layers may be produced by, for example, preparing porous materials necessary for forming the porous material layers consitituing the present floor mat, and then,

(1) inserting a fusible porous sheet (such as a nonwoven fabric or a net) which can be fused at a temperature not affecting the properties of the porous material layers for the present floor mat, between each of the porous material layers, and integrating the porous material layers by heating to a fusing temperature of the fusible porous sheet,

(2) applying hot-melt resins between each of the porous material layers, and applying a pressure to integrate the layers, or

(3) fusing fusible resin constituting one or more porous material layers to integrate the layers by fusion.

When the peripheral portion of the present floor mat or the present slip-proof floor mat for an automobile is unsightly, or when the present floor mat or the present slip-proof floor mat for an automobile contains a fiber sheet layer and thus the fibers may drop out of the floor mat, it is preferable that the peripheral portion is covered with threads by a serging process, or by a taping process, or the peripheral portion is heat-fused, or covered with the resin as mentioned above.

When the projected portions of the slip-resistant resins are located on the exposed surface of the reverse side layer of the floor mat, the above-mentioned methods may be used. The application of the projected portions of the slip-resistant resins can be carried out before or after the laminating of the porous material layers.

Particular embodiments of the floor mat or the slip-proof floor mat for an automobile according to the present invention will be explained hereinafter, referring to FIGS. 6 to 8 which is a schematic exploded sectional view of each embodiment, respectively.

The floor mat 20 as shown in FIG. 6 contains (1) the carpet layer 21 containing a pile layer 21a and a substrate layer 21b, as the porous material layer of the upper surface layer, (2) the fine-fibers nonwoven fabric layer 23 containing the fine fibers having a diameter of 10 μm or less and impregnated with resins, as the porous material layer of the reverse side layer, and (3) the foam layer 22 between the carpet layer 21 and the fine-fibers nonwoven fabric layer 23. The carpet layer 21 and the foam layer 22 can be adhered to each other by coating a foamed latex on the carpet and drying the latex. The foam layer 22 and the fine-fibers nonwoven fabric layer 23 can be adhered to each other, via a hot-melt adhesive sheet 25. The floor mat 20 has an excellent decorative function, because it contains the carpet layer 21. The floor mat 20 can effectively prevent rainwater, muddy water, spilled drinks or the like from reaching the carpet floor, and a sound absorbing property is enhanced with an interaction of the carpet floor, because it contains the fine-fibers nonwoven fabric layer 23 having a dense structure. The floor mat 20 has a cushioning property provided from the foam layer 22 located between the carpet layer 21 and the fine-fibers nonwoven fabric layer 23. Further, the foam layer 22 can relieve an influence of the concave-convex structure of substrate layer 21b on the reverse side of the carpet layer 21 so that the carpet layer 21 can be tightly adhered to the fine-fibers nonwoven fabric layer 23. Therefore, a peeling of the carpet layer 21 or the fine-fibers nonwoven fabric layer 23 rarely occurs.

The floor mat 20 as shown in FIG. 7 further contains as the porous material layer, the foam layer 24 having the concave-convex structure on the exposed surface of the reverse side layer. The structure and the producing process of the floor mat 20 as shown in FIG. 7 are the same as those of the floor mat 20 as shown in FIG. 6, except that the foam layer 24 is adhered to the fine-fibers nonwoven fabric layer 23 by coating a foamed latex on the fine-fibers nonwoven fabric layer 23 and drying the latex. In the floor mat 20 as shown in FIG. 7, the reverse side layer is the foam layer 24 having the concave-convex structure on the exposed surface, and therefore, the floor mat 20 can be effectively prevented from slipping.

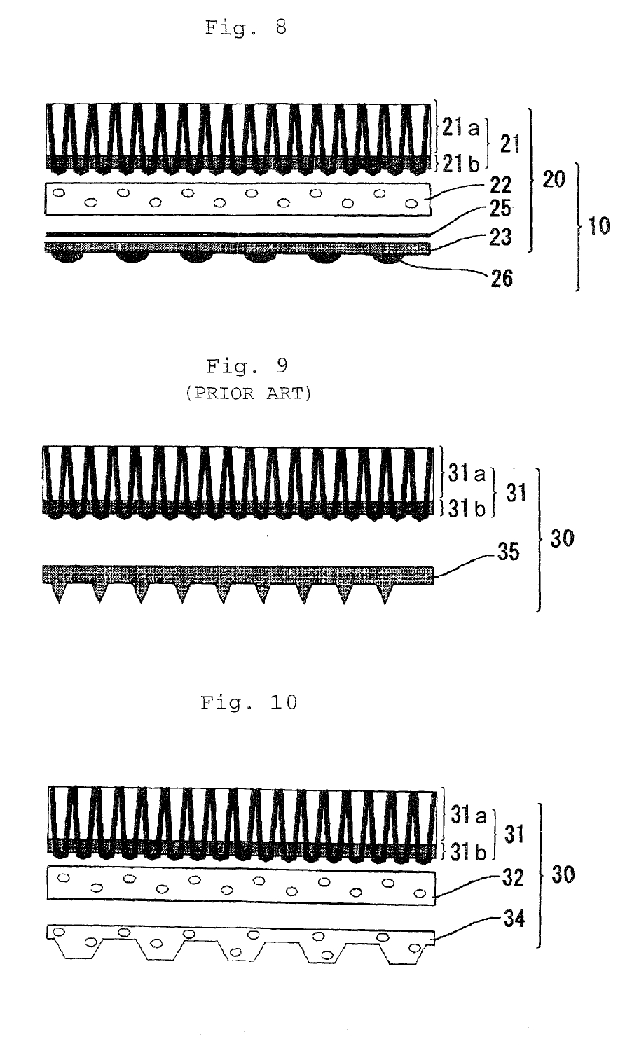

FIG. 8 illustrates the slip-proof floor mat 10 containing slip-resistant resins 26 partially located on the exposed surface of the fine-fibers nonwoven fabric layer 23 as the reverse side layer of the floor mat 20 as shown in FIG. 6. Therefore, the slip-proof floor mat 10 as shown in FIG. 8 can be effectively prevented from slipping because of the slip-resistant resins 26.

As mentioned, the floor mat or the slip-proof floor mat according to the present invention is laid over a carpet floor in an automobile. When the carpet floor on which the present floor mat or the present slip-proof floor mat is laid in the automobile has a sound absorbing property, an excellent absorbing function is obtained with an interaction of the carpet floor. For example, the floor mat or the slip-proof floor mat according to the present invention may be preferably laid over a carpet floor as disclosed in WO98/18657, that is, a carpet floor comprising a porous cushioning layer having a concave-convex structure capable of partially forming an air layer, a lightweight rigid layer containing microporous and having a total resistance of 500 to 2500 Nsm⁻³ to air, an area density of 300 to 2000 g/m², and rigidity of 0.005 to 10.5 Nm, and a carpet layer, and located so that the concave-convex structure of the cushioning layer is brought into direct contact with the automobile body. A lightweight and excellent sound-absorbing automobile can be provided by the above combination.

### EXAMPLES

The present invention will now be further illustrated by, but is by no means limited to, the following Examples.

### Example 1

A tufted carpet composed of a pile layer (area density=600 g/m²) of nylon fibers, and a primary substrate layer (area density=100 g/m²) supporting the pile layer. The substrate layer was a spun-bonded nonwoven fabric of polyester fibers. On the reverse side of the primary substrate layer, a latex mainly composed of a styrene-butadiene copolymer was coated in an amount of 270 g/m² (dry weight).

Then, a mechanically expanded latex of a styrene-butadiene copolymer was coated on the reverse side of the resulting tufted carpet so that an area density of the foam layer produced from the latex became 500 g/m² (dry weight), and dried to integrate the tufted carpet and the styrene-butadiene foam (open-cell structure; foaming magnification=7 fold; thickness=5 mm; apparent density=0.1 g/cm³).

A spun-bonded nonwoven fabric composed of long dividable fibers was treated with a water jet. The long dividable fiber had an orange-like cross-sectional shape as shown in FIG. 1, was composed of 6 nylon components and polyethylene terephthalate components, and was dividable into 16 fibers. As a result of the hydro-entanglement, a hydro-entangled nonwoven fabric (area density=100 g/m²; ratio of fine fibers=100%; thickness=0.4 mm; apparent density=0.25 g/cm³) composed of 6 nylon long fine fibers (fiber diameter=3 μm; cross-sectional shape of fiber=generally triangle) and polyethylene terephthalate long fine fibers (fiber diameter=3 μm; cross-sectional shape of fiber=generally a triangle) was prepared.

Then, the resulting hydro-entangled nonwoven fabric was impregnated with a fluoride water-repellant (dry mass=5 g/m²).

Further, a polyamide based hot-melt web [melting point=126° C. (DSC method); area density=25 g/m²] was prepared.

Subsequently, the tufted carpet, the styrene-butadiene copolymer foam, the polyamide based hot-melt web, and the hydro-entangled nonwoven fabric composed of long fine fibers impregnated with a water-repellant were laminated in the sequence of from the upper surface layer to the reverse side layer, and the laminate was heated at 140° C. under the linear pressure of 0.6 N/cm to fuse the polyamide based hot-melt web, integrate all of the layers, and thereby obtain the floor mat for an automobile according to the present invention having a structure as shown in FIG. 6.

### Example 2

The procedures mentioned in Example 1 were repeated, except that a wet-laid and hydro-entangled nonwoven fabric (area density=75 g/m²; ratio of fine fibers=80%; thickness=0.2 mm; apparent density=0.38 g/cm³) composed of polypropylene short fine fibers (fiber diameter=3 μm; cross-sectional shape of fiber=generally a triangle) and high-density polyethylene short fine fibers (fiber diameter=3 μm; cross-sectional shape of fiber=generally a triangle) was used instead of the hydro-entangled nonwoven fabric composed of long fine fibers impregnated with a water-repellant, to thereby obtain the floor mat for an automobile according to the present invention having a structure as shown in FIG. 6. The wet-laid and hydro-entangled nonwoven fabric used was prepared by hydro-entangling a wet-laid fiber web composed of short dividable fibers having an orange-like cross-sectional shape as shown in FIG. 1, composed of polypropylene components and high-density polyethylene components, and dividable into 16 fibers (fiber length=10 mm).

### Example 3

The procedures mentioned in Example 1 were repeated to prepare the tufted carpet integrated with the styrene-butadiene copolymer foam, the polyamide based hot-melt web, and the hydro-entangled nonwoven fabric composed of long fine fibers impregnated with a water-repellant.

Then, a mechanically expanded latex of a styrene-butadiene copolymer was coated on one side of the hydro-entangled nonwoven fabric so that an area density of the foam layer produced from the latex became 300 g/m² (dry weight), and dried to integrate the hydro-entangled nonwoven fabric and the styrene-butadiene foam (open-cell structure; foaming magnification=7 fold; thickness of convex portions=2.5 mm; apparent density=0.12 g/cm³). During the drying process, a concave-convex structure having a lattice-like shape or waffle-like shape was produced by embossing the styrene-butadiene foam.

Subsequently, the tufted carpet, the styrene-butadiene copolymer foam, the polyamide based hot-melt web, the hydro-entangled nonwoven fabric composed of long fine fibers impregnated with a water-repellant, and the styrene-butadiene copolymer foam were laminated in the sequence of from the upper surface layer to the reverse side layer, and the laminate was heated at 140° C. under the linear pressure of 0.6 N/cm to fuse the polyamide based hot-melt web, integrate all of the layers, and thereby obtain the floor mat for an automobile according to the present invention having a structure as shown in FIG. 7.

### Example 4

The procedures mentioned in Example 1 were repeated to prepare the tufted carpet integrated with the styrene-butadiene copolymer foam, the polyamide based hot-melt web, and the hydro-entangled nonwoven fabric composed of long fine fibers impregnated with a water-repellant.

Then, dots of a paste containing acrylonitrile-ethylene-styrene copolymer (a slip resistance value=1.2 N) were coated in a hound's tooth check pattern so that dots were placed on intersecting points thereof, on one side of the hydro-entangled nonwoven fabric composed of long fine fibers impregnated with a water-repellant, by a galvanized cylinder (shape of opening=circle; diameter of opening=1.2 mm; ratio of openings=30%), and dried (dry weight=25 g/m²).

Subsequently, the tufted carpet, the styrene-butadiene copolymer foam, the polyamide based hot-melt web, and the hydro-entangled nonwoven fabric having acrylonitrile-ethylene-styrene copolymer dots on the reverse side were laminated in the sequence of from the upper surface layer to the reverse side layer, and the laminate was heated at 140° C. under the linear pressure of 0.6 N/cm to fuse the polyamide based hot-melt web, and integrate all of the layers, and thereby obtain the slip-proof floor mat for an automobile according to the present invention having a structure as shown in FIG. 8.

### Example 5

The procedures mentioned in Example 3 were repeated, except that a tufted carpet composed of a pile layer (area density=600 g/m²) of nylon fibers, and a primary substrate layer (area density=120 g/m²) supporting the pile layer was used instead of the tufted carpet in Example 3, to thereby obtain the floor mat for an automobile according to the present invention having a structure as shown in FIG. 7. The substrate layer in the tufted carpet used was a woven fabric of polypropylene fibers, and on the reverse side of the primary substrate layer, a latex mainly composed of a styrene-butadiene copolymer was coated in an amount of 270 g/m² (dry weight).

### Example 6

A tufted carpet composed of a pile layer (area density=1200 g/m²) of polypropylene fibers, and a primary substrate layer (area density 250 g/m²) supporting the pile layer. The substrate layer was a spun-bonded nonwoven fabric of polyester fibers. On the reverse side of the primary substrate layer, a latex containing a styrene-butadiene copolymer as a main component and a fluoride water-repellent was coated in an amount of 250 g/m² (dry weight).

Further, a bulky nonwoven fabric (area density=70 g/m²; thickness=2 mm; apparent density=0.035 g/cm³) was prepared by entangling a fiber web composed of 100% of polyethylene terephthalate fibers (6.6 dtex) by a needle punching.

Then, a mechanically expanded latex of a styrene-butadiene copolymer was coated on the reverse side of the resulting tufted carpet so that an area density of the foam layer produced from the latex became 1000 g/m² (dry weight), and dried after laminating the bulky nonwoven fabric, to thereby integrate the tufted carpet, the foam layer (open-cell structure; foaming magnification=2.5 fold; thickness=4 mm; apparent density=0.25 g/cm³), and the bulky nonwoven fabric and obtain a tri-layered sheet.

Subsequently, a mechanically expanded latex of a styrene-butadiene copolymer was coated on the surface of the bulky nonwoven fabric so that an area density of the foam layer produced from the latex became 500 g/m² (dry weight), and dried to integrate the tri-layered sheet and the styrene-butadiene copolymer foam (open-cell structure; foaming magnification=3 fold; thickness in convex portions=1 mm; apparent density=0.5 g/cm³), and obtain the floor mat for an automobile according to the present invention. During the drying process, a concave-convex structure having a lattice-like shape or waffle-like shape was produced by embossing the styrene-butadiene foam.

### Comparative Example 1

The tufted carpet as used in Example 1 and a styrene-butadiene rubber sheet (area density=1.40 kg/m²) were prepared.

The tufted carpet and the styrene-butadiene rubber sheet were laminated so that the primary substrate was brought into contact with the styrene-butadiene rubber sheet, and then a press plate having channels for forming nibs was used to integrate the laminate, form nibs, and carry out vulcanization to obtain the comparative floor mat for an automobile having a structure as shown in FIG. 9.

### Comparative Example 2

The tufted carpet as used in Example 1 was prepared.

Then, on the primary substrate of the tufted carpet, a melt-extruded styrene-butadiene copolymer elastomer was laminated. A roll having channels for forming nibs was used to integrate the tufted carpet and the styrene-butadiene copolymer elastomer and form nibs to obtain the comparative floor mat for an automobile having a structure as shown in FIG. 9.

### Comparative Example 3

The tufted carpet integrated with the styrene-butadiene copolymer foam (foam A) as used in Example 1 was prepared.

Then, a mechanically expanded latex of a styrene-butadiene copolymer was coated on a surface of the styrene-butadiene copolymer foam (foam A) so that an area density of the foam layer produced from the latex became 300 g/m² (dry weight), and dried to integrate the styrene-butadiene copolymer foam (foam A) and the styrene-butadiene copolymer foam (foam B; open-cell structure; foaming magnification=7 fold; thickness=2.5 mm; apparent density=0.12 g/cm³) to obtain the comparative floor mat for an automobile having a structure as shown in FIG. 10. During the drying process, a concave-convex structure having a lattice-like shape or waffle-like shape was produced by embossing the the styrene-butadiene copolymer foam (foam B).

### Comparative Example 4

A bulky nonwoven fabric (area density=400 g/m²; thickness=5 mm; apparent density=0.08 g/cm³) was prepared by entangling a fiber web composed of 100% polyethylene terephthalate fibers (6.6 dtex) by a needle punching. Then, the bulky nonwoven fabric was impregnated with a fluoride water-repellant (dry mass=5 g/m²).

Further, the tufted carpet and the polyamide based hot-melt web as used in Example 1 were prepared.

Subsequently, the tufted carpet, the polyamide based hot-melt web, and the bulky nonwoven fabric impregnated with a water-repellant were laminated in the sequence of from the upper surface layer to the reverse side layer, and the laminate was heated at 140° C. under the linear pressure of 0.6 N/cm to fuse the polyamide based hot-melt web, integrate all of the layers, and thereby obtain the comparative floor mat for an automobile.

Evaluation of Properties

(1) Determination of a water-resistant pressure

A water-resistant pressure of each of the floor mats for an automobile prepared in Examples 1 to 6 and Comparative Examples 1 to 4 was determined in accordance with the above-mentioned method. The results are shown in Table 1.

(2) Evaluation of property of preventing staining

A sample 50 cm×50 cm) was prepared by cutting each of the floor mats for an automobile prepared in Examples 1 to 6 and Comparative Examples 1 to 4. Then, the sample was laid on a carpet floor and 200 mL of water colored with ink was dropped on the center of the sample. After 48 hours, a stained condition was evaluated. The results are shown in Table 1. The evaluation was carried out in accordance with the following two ratings:

X . . . The colored water reached the carpet floor and the carpet floor was stained

◯ . . . The colored water did not reach the carpet floor and the carpet floor was not stained

It is assumed from the results of “(1) Determination of a water-resistant pressure” and “(2) Evaluation of property for preventing staining” that a floor mat having a water-resistant pressure of 40 mmH₂O or more can prevent rainwater, muddy water, spilled drinks or the like from reaching and staining the carpet floor.

(3) Determination of permeability

A permeability of each of the whole floor mats for an automobile prepared in Examples 1 to 6 and Comparative Examples 1 to 4, and each of the carpet layers alone therein, was determined in accordance with the above-mentioned method. The results are shown in Table 1. Further, a permeability of each of the foam layers as the reverse side layers alone in the floor mat for an automobile prepared in Examples 3, 5 and 6 and Comparative Example 3 was determined. The results are shown in Table 2.

TABLE 1

| | | Water- | Property | Permeability |
|---|---|---|---|---|
| | Permeability | resistant | of | of carpet |
| | of floor mat | pressure | preventing | layer |
| | (mL/cm²/sec) | (mm H₂O) | staining | (mL/cm²/sec) |
| Example 1 | 5.5 | 310 | O | 7.3 |
| Example 2 | 4 | 85 | O | 7.3 |
| Example 3 | 3.3 | 380 | O | 7.3 |
| Example 4 | 5.3 | 320 | O | 7.3 |
| Comparative | 0 | 2,000< | O | 7.3 |
| Example 1 | | | | |
| Comparative | 0 | 2,000< | O | 7.3 |
| Example 2 | | | | |
| Comparative | 48.5 | 0 | X | 7.3 |
| Example 3 | | | | |
| Example 5 | 0.3 | 400 | O | 0.5 |
| Comparative | | | | |
| Example 4 | 10.5 | 10 | X | 7.3 |
| Example 6 | 4.8 | 150 | O | 55 |

TABLE 2

| | Permeability of |
|---|---|
| | reverse foam layer |
| | (mL/cm^{2/sec)} |
| Example 3 | 3.4 |
| Comparative | 3.4 |
| Example 3 | |
| Example 5 | 3.4 |
| Example 6 | 5.0 |

(4) Evaluation of sound absorbing property

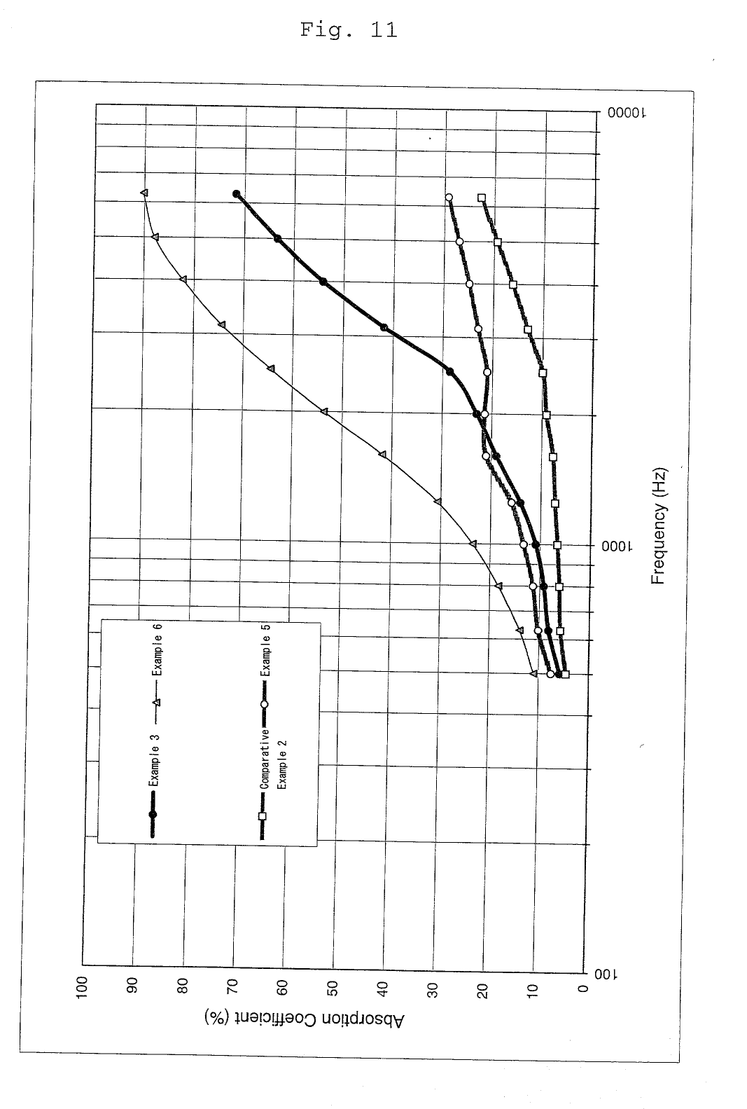

A sound absorbing property is evaluated by a tester Brüel & kjær, in accordance with ISO 10534-2 “Acoustics-Determination of sound absorption coefficient and impedance in impedance tubes, Part 2: Transfer-Function method”. The results are shown in FIG. 11.

It is apparent from the results of Examples 3 and 5 that the floor mat containing the carpet layer alone having a high permeability exhibits a more excellent sound absorbing property. Further, it is apparent from the results of Example 3 and Comparative Example 2 that the whole floor mat for an automobile having a higher permeability exhibits a more excellent sound absorbing property. Still further, it is apparent from the results of Example 3 and 6 that the floor mat for an automobile having a carpet layer with a higher area density exhibits a more excellent sound absorbing property, particular for a treble sound.

As above, the floor mat for an automobile according to the present invention (Examples 1 to 6) has a permeability higher than that of the conventional floor mat (Comparative Examples 1 to 4). Therefore, it is assumed that when a functional substance such as a deodorant or an aromatic is contained, the functions can be effectively exhibited, and when the carpet floor has a sound absorbing property, the present floor mat can exhibit an excellent sound absorbing property utilizing the sound absorbing property of the carpet floor.

The floor mat for an automobile according to the present invention consists essentially of one or more porous material layers wherein a water-resistant pressure of the whole floor mat is 40 mmH₂O or more.

As above, the present floor mat for an automobile is weight-saving because it consists essentially of one or more porous material layers, and rainwater, muddy water, spilled drinks or the like are less likely to permeate the floor mat and stain the carpet floor, because the water-resistant pressure of the whole floor mat is 40 mmH₂O or more.

When the whole floor mat for an automobile according to the present invention has a permeability of 0.3 mL/cm²/sec or more, it exhibits a sound absorbing property. Further, when a carpet floor on which the present floor mat is laid in the automobile has a sound absorbing property, an excellent absorbing function is obtained. Further, the floor mat according to the present invention may contain a deodorant, an aromatic, an antimicrobial agent, a fungicide, or the like. In particular, a deodorant, an aromatic, an antimicrobial agent, a fungicide, or the like can effectively exhibit their properties when contained in the present floor mat having a permeability of 0.3 mL/cm²/sec or more.

When the floor mat for an automobile according to the present invention has the carpet layer as the porous material layer of an upper surface layer, it has an excellent decorative effect. When a permeability of the carpet upper surface layer alone is 2 mL/cm²/sec or more, permeable properties of other porous material layers located under the carpet upper surface layer can be effectively exhibited, and a sound absorbing property of the whole floor mat becomes excellent. When a carpet floor on which the present floor mat is laid in the automobile has a sound absorbing property, an excellent absorbing function is obtained. Further, when a deodorant, an aromatic, an antimicrobial agent, a fungicide, or the like is contained in the present floor mat having the carpet upper surface layer with a permeability of 2 mL/cm²/sec or more alone, their properties can be effectively exhibited.

When the floor mat for an automobile according to the present invention contains the fine-fibers nonwoven fabric layer comprising fine fibers having a diameter of 10 μm or less is contained as the porous material layer of an intermediate layer and/or a reverse side layer, rainwater, muddy water, spilled drinks or the like can be effectively prevented from reaching the carpet floor in an automobile. Further, a sound absorbing property is enhanced with an interaction of the carpet floor. When the fine-fibers nonwoven fabric layer contains a resin, the structure thereof becomes denser. Therefore, rainwater, muddy water, spilled drinks or the like can be more effectively prevented from reaching to the carpet floor, and a sound absorbing property is further enhanced.

When the floor mat for an automobile according to the present invention contains the foam layer as the porous material layer of an intermediate layer and/or a reverse side layer, it may exhibit various functions such as a cushioning property. When the floor mat has the foam layer as the reverse side layer, a slip-resistant property is obtained.

When the reverse side layer in the floor mat for an automobile according to the present invention has a permeability of 0.3 to 20 mL/cm²/sec alone, a sound (particularly a treble sound of 2000 Hz or more) impinged from the reverse side of the floor mat can be reflected, to keep the inside of an automobile quiet.

When an exposed surface of the foam layer as the reverse side layer in the floor mat for an automobile according to the present invention has a concave-convex structure, the convex portions can bite into the carpet floor of the automobile to enhance a slip resistance of the floor mat.

Further, the slip-proof floor mat for an automobile according to the present invention comprises projected portions of the slip-resistant resin having a slip resistance value of 0.6N or more, partially located on the exposed surface of the reverse side layer of the above-mentioned present floor mat.

When the projected portions of the slip-resistant resin having a slip resistance value of 0.6N or more are partially located on the exposed surface of the reverse side layer of the floor mat, a slip-resistant property of the floor mat for an automobile is enhanced without affecting the weight-saving of the floor mat. An apparent permeability of the floor mat can be maintained even if the slip-resistant resins are partially located on the exposed surface, and therefore, the slip-proof floor mat exhibits an excellent absorbing function with an interaction of the carpet floor. Further, when a deodorant, an aromatic, or the like is contained in the present slip-proof floor mat, their properties can be effectively exhibited. Furthermore, when the water-resistant pressure of the whole slip-proof floor mat is 40 mmH₂O or more, the carpet floor is less likely stained.

As above, the present invention was explained with reference to particular embodiments, but modifications and improvements obvious to those skilled in the art are included in the scope of the present invention.

1. A floor mat for an automobile consisting essentially of one or more porous material layers wherein a water-resistant pressure of a whole floor mat is 40 mmH₂O or more.

2. The floor mat for an automobile according to claim 1, wherein a permeability of the whole floor mat is 0.3 mL/cm²/sec or more.

3. The floor mat for an automobile according to claim 1, wherein the porous material layer as an upper surface layer of the floor mat is a carpet layer.

4. The floor mat for an automobile according to claim 3, wherein a permeability of the carpet upper surface layer alone is 2 mL/cm²/sec or more.

5. The floor mat for an automobile according to claim 1, containing a fine-fibers nonwoven fabric layer comprising fine fibers having a diameter of 10 μm or less, as the porous material layer of an intermediate layer and/or a reverse side layer.

6. The floor mat for an automobile according to claim 5, wherein the fine-fibers nonwoven fabric layer further contains a resin.

7. The floor mat for an automobile according to claim 1, containing a foam layer, as the porous material layer of an intermediate layer and/or a reverse side layer.

8. The floor mat for an automobile according to claim 1, wherein a permeability of the reverse side layer alone is 0.3 to 20 mL/cm²/sec.

9. The floor mat for an automobile according to claim 7, wherein an exposed surface of the foam layer as the reverse side layer has a concave-convex structure.

10. A slip-proof floor mat for an automobile comprising (1) the floor mat according to claim 1 and (2) projected portions of a slip-resistant resin having a slip resistance value of 0.6 N or more, the projected portions being partially located on an exposed surface of a reverse side layer of the floor mat.

11. The slip-proof floor mat for an automobile according to claim 10 wherein a water-resistant pressure of the whole slip-proof floor mat is 40 mmH₂O or more.
